(19) United States
(12) Patent Application Publication
(10) Pub. No.: US 2009/0313227 A1
(43) Pub. Date: Dec. 17, 2009

(54) Searching Using Patterns of Usage

(75) Inventors: Ted Dunning, Mountain View, CA (US); John Dimm, San Diego, CA (US); Alexander Sherbak, San Diego, CA (US)

Correspondence Address: RAUBVOGEL LAW OFFICE, 820 LAKEVIEW WAY, REDWOOD CITY, CA, 94062, US

(73) Assignee: VEOH NETWORKS, INC., San Diego, CA (US)

(21) Appl. No.: 12/483,142

(22) Filed: Jun. 11, 2009

Related U.S. Application Data
(60) Provisional application No. 61/061,605, filed on Jun. 14, 2008.

(51) Int. Cl. G06F 17/30

(52) U.S. Cl. 707/3; 707/E17.055

(57) ABSTRACT

In various embodiments, the present invention relates disparate objects based on user behavior, thus enabling search engines to provide more comprehensive and accurate results. According to various embodiments of the present invention, multiple kinds of interactions by users with multiple classes of objects can be analyzed. The result is that disparate classes of objects can be related. Derived relations between text and objects can be used to implement search-like functionality or to extend a conventional text retrieval system.

In one embodiment, the present invention is used to improve search results and/or recommendations by employing a filtered co-occurrence matrix that provides a representation as to which queries tend to co-occur with the originally submitted query. By supplementing or replacing the original query with co-occurring queries, the system of the present invention is able to generate results that are more likely to be of interest.

### CROSS-REFERENCE TO RELATED APPLICATIONS

The present application claims priority from U.S. Provisional Patent Application No. 61/061,605, filed on Jun. 14, 2008 and entitled “Search System Using Patterns of Usage,” (Atty. Docket No. VN005-PROV), the disclosure of which is incorporated herein by reference.

The present application is related to U.S. patent application Ser. No. 12/023,597, filed on Jan. 31, 2008 and entitled “Indicator-Based Recommendation System,” (Atty. Docket No. VN004), the disclosure of which is incorporated herein by reference.

### BACKGROUND OF THE INVENTION

1. Field of the Invention

The invention generally relates to search techniques, and, more specifically, to relating disparate objects based on user behavior so as to provide more comprehensive and accurate search results.

2. Description of Background Art

With the growing amount of video content and other multi-media content available via the Internet, it is becoming increasingly useful to provide and support robust search capability to allow users to identify and locate content items of interest, and to provide recommendations regarding content items that may be of interest.

One difficulty in searching for and/or recommending multi-media objects, such as video content items, on a large scale is that the available meta-data for such multi-media objects (such as title, description and/or tags) is often very poor (even intentionally misleading). In addition, it is often difficult to determine which multi-media object is worth consuming based on an examination of meta-data alone. In many cases, social factors completely apart from the content or description of the multi-media content may dominate consumer decisions about multi-media content.

The combination of poor meta-data and large cultural effects often causes conventional search and/or recommendation systems to produce poor results when applied to multi-media search problems.

Some existing systems attempt to extract meta-data directly from multi-media content. See, for example, Douglas Turnbull, Luke Barrington, and Gert Lanckriet, Modeling Music And Words Using A Multi-Class Naive Bayes Approach. International Conference on Music Information Retrieval (ISMIR), October 2006; Tom Sulzer, Moodlogic, http://en.wikipedia.org/wiki/MoodLogic. These systems suffer from the fact that they are inherently unable to capture cultural factors. Furthermore, capturing meta-data reliably is often difficult and CPU-intensive.

Some systems depend on human experts to capture meta-data directly from content. However such systems are infeasible at web-scale due to the cost and delays inherent in human review. In many cases, human extraction of content meta-data is similar to automated content meta-data extraction in that it cannot incorporate cultural factors.

Other web search engines use anchor text to move descriptive text from web pages to the pages that they link to. See, for example, Sergey Brin and Lawrence Page. The Anatomy Of A Large-Scale Hypertextual Web Search Engine. Computer Networks and ISDN Systems, 30(1-7):107-117, 1998. This practice has a strong positive effect in heavily linked text corpora such as the web. However, multi-media content is often only weakly referenced even in a highly link-friendly environment such as the web. When it is available, such anchor text can improve meta-data quality for multi-media search, but it is only rarely available.

Some search engines attempt to address the poor precision attained by pure meta-data search of multi-media data by recording the presentation of search results as well as the selection of specific multi-media objects by users. This allows these search engines to use statistical techniques to determine which multi-media objects get more clicks than would be explained simply by their position in the search results list. See, for example, U.S. patent application Ser. No. 12/023,597, filed on Jan. 31, 2008 and entitled “Indicator-Based Recommendation System,” (Atty. Docket No. VN004), the disclosure of which is incorporated herein by reference. This technique can help precision, but it does not necessarily help recall; if the available meta-data for a video does not match the query in question, then it will not appear in the search results and no click-based adaptation is possible.

Some existing recommendation systems use a history of how users interact with some set of objects to structure suggestions for additional interactions. These recommendation systems can explicitly use feedback where users express their preferences through ratings or they can use implicit data where users' preferences are inferred by observing which objects they view, purchase, or otherwise in-teract with. Implicit data has the virtues that it is considerably more plentiful than explicit data and that it has fewer problems of interpretation than explicit data. See, for example: Upendra Shardanand and Patti Maes. Social information filtering: Algorithms For Automating “Word Of Mouth” in Proceedings of ACM CHI'95 Conference on Human Factors in Computing Systems, volume 1, pages 210-217, 1995; James Bennett and Stan Lanning. The Netflix Prize. In Proceedings of KDD Cup and Workshop 2007, 2007; and Greg Linden, Brent Smith, and Jeremy York, Amazon.com Recommendations: Item-To-Item Collaborative Filtering, IEEE Internet Computing, 7(1):76-80, January/February 2003.

Previous recommendation systems tend to be dyadic in nature, in that the universe of discourse involves two kinds of objects related by a single relation. See, for example, Thomas Hofmann and Jan Puzicha, Unsupervised learning from dyadic data. Technical Report TR-98-042, International Computer Science Institute, Berkeley, Calif., 1998. In consumer multi-media applications, it is common for one of these kinds of object to be a user and the other kind to be a multi-media object such as a video or audio recording and the primary relation between the objects consists of the user viewing or listening or otherwise consuming the multimedia object. More generally, recommendation systems can be p-adic in which the observed relations are no longer dyadic but instead represent bitransitive predicates, as described in U.S. patent application Ser. No. 12/023,597, filed on Jan. 31, 2008 and entitled “Indicator-Based Recommendation System,” (Atty. Docket No. VN004), the disclosure of which is incorporated herein by reference. Generally, these systems make use of co-occurrence data in that links are inferred between two objects if large numbers of users interacted with both objects.

What is needed is a search system and method that improves the effectiveness of multi-media searches, and that provides useful, high-quality results even in view of the above-described limitations and factors. What is further needed is a search system and method for multi-media searches that avoids the need to extract meta-data directly from multi-media content and does not depend on human experts to capture meta-data directly from content. What is further needed is a search system and method for multi-media searches that avoids the problems, inefficiencies, and limitations of the above-described techniques.

### SUMMARY OF THE INVENTION

In various embodiments, the present invention relates disparate objects based on user behavior, thus enabling search and/or recommendation engines to provide more comprehensive and accurate results. The method extends conventional dyadic recommendation technology in which users are related to a single class of objects by behavior and consequently objects in that single class are related to each other. According to various embodiments of the present invention, multiple kinds of interactions by users with multiple classes of objects can be analyzed. The result is that disparate classes of objects can be related.

In some embodiments, where one (or more) of the classes involves textual or text-like information, the derived relations between text and objects can be used to implement search-like functionality or to extend a conventional text retrieval system.

One application of the present invention is to improve search results and/or recommendations by employing a filtered co-occurrence matrix. The filtered co-occurrence matrix provides a representation as to which queries tend to co-occur with the originally submitted query. By supplementing or replacing the original query with co-occurring queries, the system of the present invention is able to generate results that are more likely to be of interest, even when little or no content directly related to the original query exists.

### BRIEF DESCRIPTION OF THE DRAWINGS

FIG. 1 is a block diagram depicting data flow from log files to query-to-video mapping, according to one embodiment.

FIG. 2 is a block diagram depicting the use of query-to-video mapping to augment a text retrieval index, according to one embodiment.

FIG. 3 is a block diagram depicting query categorization according to one embodiment.

FIG. 4 is a block diagram depicting derivation of category assignments for videos using derived query categories and a set of query-to-video recommendations, according to one embodiment.

FIG. 5 depicts an example of search results from a conventional weighted term retrieval engine.

FIG. 6 depicts a list of queries related to an initial query term, produced by co-occurrence analysis.

FIG. 7 depicts an example of search results related to an initial query term by filtered co-occurrence.

FIG. 8 depicts an example of search results from a conventional weighted term retrieval engine.

FIG. 9 depicts a list of queries related to an initial query term, produced by co-occurrence analysis.

FIG. 10A depicts an example of search results generated using query-to-video mapping, according to one embodiment.

FIG. 10B depicts an example of a user interface for presenting search results generated using query-to-video mapping, according to one embodiment.

FIG. 11 depicts an example of search results for a misspelled query, from a conventional weighted term retrieval engine.

FIG. 12 depicts a list of queries related to an initial misspelled query, produced by co-occurrence analysis.

FIG. 13A depicts an example of search results for a misspelled query, improved by filtered co-occurrence according to one embodiment.

FIG. 13B depicts an example of a user interface for presenting search results for a misspelled query, improved by filtered co-occurrence according to one embodiment.

FIG. 14 depicts an example of an architecture for implementing the present invention according to one embodiment.

FIG. 15 depicts an example of a web page for entry of a query.

FIG. 16 is a flow diagram illustrating a method for generating search results and/or recommendations according to one embodiment of the present invention.

One skilled in the art will recognize that the particular layouts and arrangements shown in the Figures are merely exemplary, and that the invention can be implemented in many other ways without departing from the essential characteristics as set forth in the claims.

### DETAILED DESCRIPTION OF THE EMBODIMENTS

### System Architecture

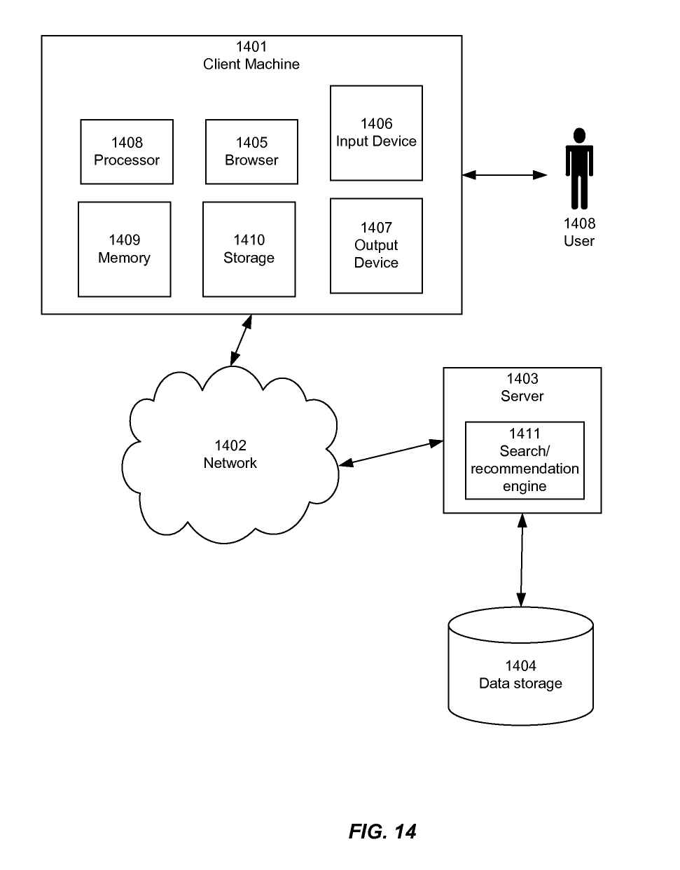

Referring now to FIG. 14, there is shown an example of an architecture for implementing the present invention in a client/server architecture operating over a network, according to one embodiment. In such an embodiment, client machine 1401 communicates with server 1403 across a network 1402 such as the Internet. Client machine 1401 can be a personal computer, computing device, or other electronic device such as a kiosk, telephone, cellular telephone, handheld computer, personal digital assistant, or the like. Client machine 1401 includes, in one embodiment: processor 1408; memory 1409; storage 1410; input device 1406 such as a keyboard, mouse, touchpad, or the like; output device 1407 such as a display screen; and other hardware components as are well known for computing devices and/or other electronic devices. Client machine 1401 may run an operating system such as Microsoft Windows Vista, available from Microsoft Corporation of Redmond, Wash.

In one embodiment, browser software 1405 runs on client machine 1401 enabling user 1408 to interact with web pages available on the World Wide Web and delivered to client machine 1401 via network 1402. One example of browser 1405 is Microsoft Internet Explorer, available from Microsoft Corporation of Redmond, Wash.

In one embodiment, the present invention is implemented as functionality that runs on a server 1403. Using browser 1405, user 1408 accesses a web page associated with server 1403. As described in more detail below, user 1408 submits a query at the web page. Search/recommendation engine 1411 running at server 1403 responds to the query by obtaining relevant information from data storage 1404 and transmitting query results back to client machine 1401 for presentation to user 1408. Additional details concerning such operations are described below. Data storage 1404 can include any or all of the following: content items, indexes, pointers to content items, and data describing relationships among content items and/or queries, according to techniques described below.

In one embodiment, the system of the present invention can be used for searching for content available on the Internet. Accordingly, user's 1408 query may contain key words, phrases, and/or longer text representing the content sought by user 1408. User 1408 may enter the query via a form at a website, for example by typing the query on a keyboard or other input device 1406, or by cutting and pasting the query from some source, or by clicking on a link or activating a bookmark or favorite representing the query. Alternatively, user 1408 may specify a document, file, web page, or other item as the source of the query parameters; for example, the entire text of a document can be used as a query, if desired.

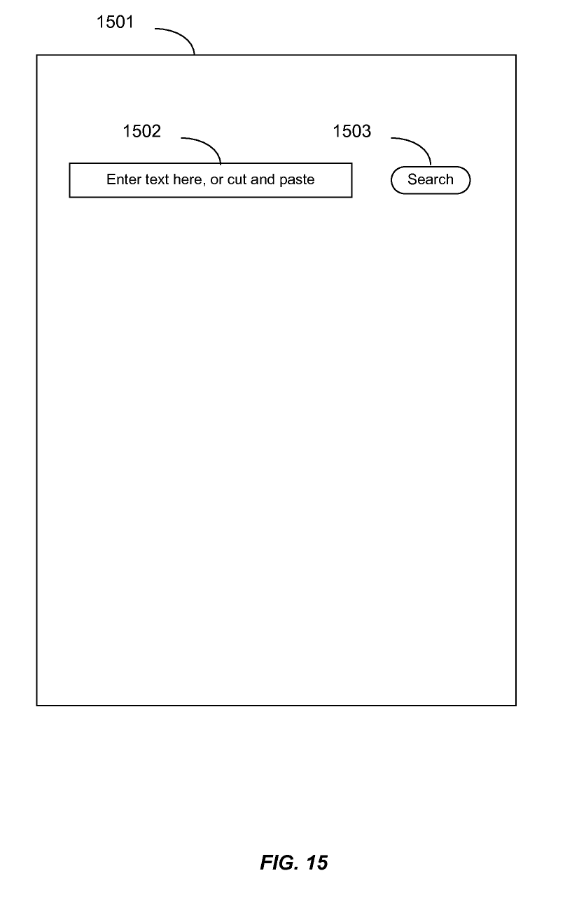

Referring now to FIG. 15, there is shown a screen shot depicting an example of a web page 1501 for entry of a query. In one embodiment, browser 1405 displays web page 1501 via output device 1407 at client machine 1401. User 1408 types the query in field 1502, or alternatively can paste text in field 1502. User 1408 clicks Search button 1503 to transmit the query to server 1403, where search/recommendation engine 1411 of the present invention generates results for presentation at client machine 1401. Further details concerning the operation of engine 1411 are described below.

One skilled in the art will recognize that the architecture shown in FIG. 14 is simplified for illustrative purposes, and that other arrangements and architectures can be implemented without departing from the essential characteristics of the invention as claimed herein. In various implementations, any number of client machines and/or servers can be provided, and the system of the present invention can handle multiple queries from multiple client machines simultaneously.

In one embodiment, search/recommendation engine 1411 receives query terms and generates search results. For purposes of the description provided herein, search/recommendation engine 1411 is, in one embodiment, a generalized search engine implemented in the form of a recommendation engine. A search engine can include any functional module that receives textual search requests and produces lists of search results. A recommendation engine can include any functional module that primarily uses usage or behavioral data to produce result lists. Considering search engine input as a special case of behavioral data, a generalized search engine can be implemented in the form of a recommendation engine.

The process of generating search results is equivalent to that of generating recommendations based on query terms, wherein the query terms can be supplied manually, copied or gathered from another source, or obtained from content items. Accordingly, for purposes of the description provided below, search functionality is considered a special case of recommendation functionality; engine 1411 is therefore referred to as a search/recommendation engine.

### Overview of Search/Recommendation Engine Operation

Conventional recommendation engines often reduce the problem of dyadic recommendation to one involving a bipartite set containing two kinds of objects, X and Y related by a single relation. In these systems, we are given training data T={(xᵢ, yᵢ, kᵢ)}, where xᵢ ε X, yᵢ ε Y and kᵢ ε R. The value kᵢ is an optional association strength, often a count of the number of interactions or simply a value from {0, 1} indicating whether any interaction happened at all. We are also given an input Z{z.ᵢ} where z.ᵢ ε Y, often a user interaction history. The training data can be viewed as a rowsets Tₓ={y|(x,y) ε T} that are sampled from some multinomial distribution with parameters P(y|x). In terms of viewing, listening or buying histories, P(y|x) represents the probability that a viewer, listener or buyer x will take the desired action on y. In general, it is desirable (i.e. it would increase the total number of views or purchases and increase general user interest) for y's with large values of P(y|x) to be presented to user x.

Since more than one item can usually be presented to a user as a recommendation, the goal of the recommendation system is to produce a result set R={rₘ} ⊂ Y such that P(rₘ|x) is large for as many of the rₘ as possible. The elements of the set R are the recommended items for user x. See, for example, the formulation described as dyadic learning in T. Hofmann, J. Puzicha, and M. Jordan, Learning From Dyadic Data, 1999.

In practice, conditioning P on each specific user has no ability to generalize to new users or new behaviors by old users. Accordingly, the model actually used expresses each user in some hidden representation so that we have

$$P ( y \vert x ) = {\sum }_{u} P ( y \vert u ) p ( u \vert x )$$

The hidden representation can take on many forms in different recommendation systems such as a set of similar users from T, latent semantic factors, or recommendation indicators. See, for example, Scott C. Deerwester, Susan T. Dumais, Thomas K. Landauer, George W. Furnas, and Richard A. Harshman, Indexing By Latent Semantic Analysis, Journal of the American Society of Information Science, 41(6):391-407, 1990.

The dyadic learning framework appears in many applications. In text retrieval, the two kinds of objects are words and documents, and the relation was whether a word appears in a document; recommendation is text retrieval with relevance feedback. See, for example, Jr. J. J. Rocchio, Relevance Feedback In Information Retrieval, in Gerard Salton, editor, The SMART Retrieval System, pages 313-323. Prentice Hall, Englewood Cliffs, N.J., 1971.

In music recommendation systems such as Musicmatch Jukebox available from Musicmatch, Inc. of San Diego, Calif., the two kinds of objects are listeners and artists, and the relation represents who listened to whose music. In SelectCast, available from HNC Software Inc., of San Diego, Calif., the two kinds of objects are consumers and vendors, and the relation represents who purchased from whom or web visitors and ads related by who clicked on what. In the recommendation system offered by Amazon.com, Inc. of Seattle, Wash., consumers and products are the kinds of objects, and who bought what is the relation. See, for example, Greg Linden, Brent Smith, and Jeremy York, Amazon.Com Recommendations: Item-To-Item Collaborative Filtering, IEEE Internet Computing, 7(1):76-80, January/February 2003. In general, these diverse systems are variants of the same general pattern in which objects of one kind interact with object of another in exactly one way.

Matrix-based techniques express subsets of X and Y as vectors with an element for each member of the set and length equal to the cardinality of the set. The training data T is expressed as a matrix A with rows corresponding to elements of X, columns corresponding to elements of Y,

$$A = \{ {a}_{xy} \}$$

$${a}_{xy} = \{ \begin{matrix}k & if ( x , y , k ) ∈ T \\ 0 & otherwise\end{matrix}$$

The goal in matrix-based methods is to use A to find a function R that maps an input z ⊂ Y to a recommendation r, such that r=Rz. In practice, Rz is often more or less a matrix product, although it is only rarely implemented as an explicit matrix using a matrix algebra package. Traditional vector-based text retrieval, as the name suggests, uses a suitably weighted and normalized version of A itself, D_{doc}ADₜₑᵣₘ where D_{doc} and Dₜₑᵣₘ are diagonal matrices that perform document normalization or term weighting, respectively. See, for example, Gerard Salton, Developments In Automatic Text Retrieval, Science, 253:974-980, 1991.

Where the elements of A are taken as binary indicators

$${a}_{xy} = \{ \begin{matrix}1 & if k > 0 \\ 0 & otherwise\end{matrix}$$

a useful R can be computed using the co-occurrence matrix C=A′A whose elements cij are the number of times columns i and j of T had non-zero elements in the same row, that is the number of unique values of l such that tₗᵢ=tₗⱼ=1. These co-occurrence counts can be filtered by the use of a statistical test as described in Ted E. Dunning, Accurate Methods For The Statistics Of Surprise And Coincidence, Computational Linguistics, 19(1):61-74, 1993.

According to various embodiments, engine 1411 of the present invention is able to generate recommendations where the available data (stored in data storage 1404) consists of multiple dyadic relations. For instance, users 1408 might issue queries to search engine 1411 (thus creating a dyadic relation between users 1408 and queries) and these same users 1408 might also view videos (thus creating a second dyadic relation between users and videos). Thus, in addition to suggesting videos to users 1408 or to suggest queries to users 1408, or to link queries to queries or videos to videos, engine 1411 of the present invention, in various embodiments, can establish connections between queries and videos based on user 1408 behavior alone.

The ability of engine 1411 of the present invention to establish such connections improves its effectiveness as a search and/or recommendation engine. The techniques of the present invention allow relationships to be inferred between queries and videos; these relationships can then be used to augment search engine results or even to replace search engine results. In one embodiment, the techniques of the present invention can be used to extend previous recommendation algorithms so that instead of (or in addition to) using co-occurrence data to infer links among a single type of object, cross-occurrence data can be used to infer links between different types of objects.

According to various embodiments, the system of the present invention provides a number of features that improve significantly on conventional search engines, particularly with respect to the use of multiple dyadic data sources to provide cross-type recommendations that can then be used as search results as if produced by a conventional search engine. In one embodiment, these cross-type recommendations automatically incorporate a variety of credit assignment mechanisms so that in cases where a few users succeed in finding desired content after failing to find desired content with an initial query, the desired content can be correctly associated with the initial query. This allows other users who might not be as facile at query refinement to find the desired content even though they are only able to produce the initial query.

Cross-occurrence derived links from queries to videos not only serve some of the function of a search engine, they can also sometimes produce search engine-like results much faster than a normal search engine can. This speed results from the fact that, according to techniques described herein, a query-to-video cross recommendation does not require a vector of occurrences to be retrieved for each term in the search query, and then combined to produce a result. Rather, a pre-computed list of video recommendations is stored for most queries that have been previously seen. Whenever one of those queries (or small transformations of these queries) is entered by a user, generation of a results list does not require any computation at all; rather, the results list can be obtained with a single lookup operation. In other cases, where the exact query has not been seen, but terms in the query have been included in queries for which recommendations are available, the recommendations for the individual terms can be combined. Since the structure of query-to-video recommendations is typically much sparser than for a typical retrieval index, even this combination of multiple recommendations is faster than normal text-based retrievals.

Although the description provided herein sets forth the invention in terms of video content items, including references to queries, recommendations, and relationships associated with such video content items, one skilled in the art will recognize that the techniques described herein can be applied to other types of content, documents, and the like. Accordingly, any references herein to particular types of content items (such as “video”) are intended to merely be illustrative and not to limit the scope of the claimed invention to those particular types of content items.

### Algorithmic Details

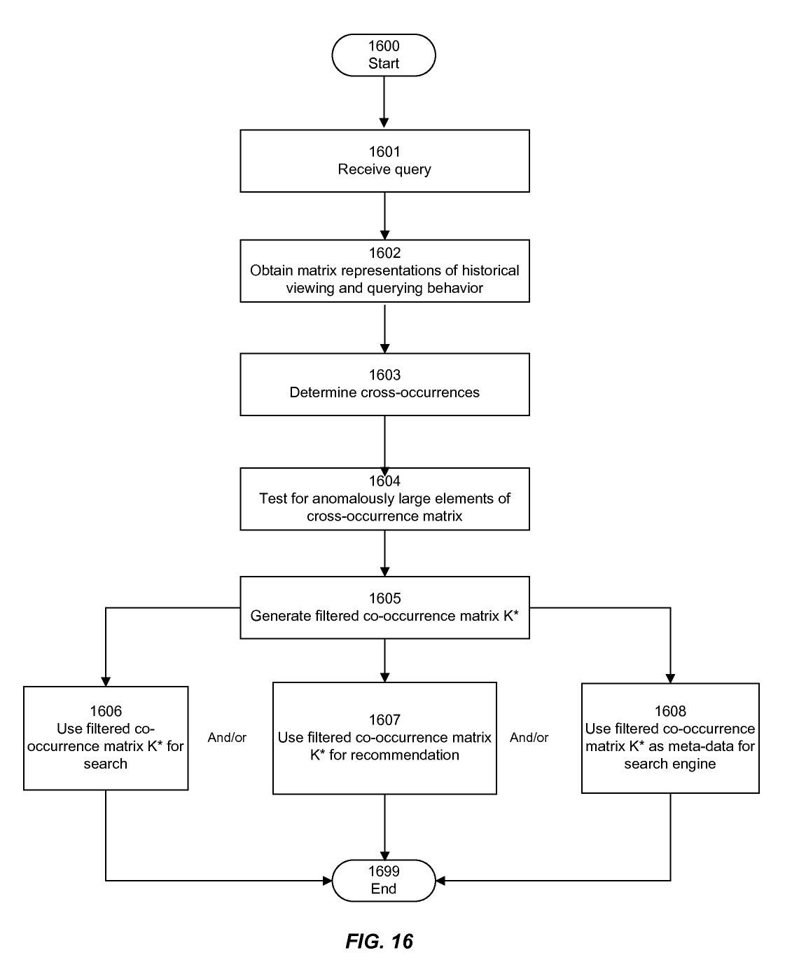

Referring now to FIG. 16, there is shown a flow diagram illustrating a method for generating search results and/or recommendations according to one embodiment of the present invention. In one embodiment, engine 1411 operating at server 1403 performs these steps in response to a query or other request for search results or recommendations, for example originating at client machine 1401.

The following description provides particulars and examples for illustrative purposes. One skilled in the art will recognize that these examples are illustrative, and are not intended to limit the scope of the claimed invention. In addition, as mentioned above, the use of the term “video” is not intended to limit the scope of the invention to video content, but is provided merely for ease of nomenclature; one skilled in the art will recognize that the techniques of the present invention can be applied to any type of content, and is not limited to videos.

For purposes of the following description, an example is presented wherein there are sets of users (U), videos (V) and queries (Q) that are related by users viewing videos and users issuing queries to search engine 1411 running on server 1403.

Engine 1411 receives 1601 a query, which may be any request for recommendations or search results, and may be based on any relevant query parameters. For example, the query may specify query terms, including words, sentence, text of documents, metatags, or the like, and/or it may be based on characteristics of previously retrieved content items.

Engine 1411 obtains 1602 representations of historical viewing and querying behavior. In one embodiment, such historical data can be represented as user-by-video and user-by-query matrices A and B respectively, as may be stored in data storage 1404 accessible by server 1403. In one embodiment, the system of the present invention ignores the number of times that any interaction happened and simply records one interaction by storing a 1 in the matrix.

A ε {0,1}^{|U∥V|}

B ε {0,1}^{|U∥V|}

A particular user is denoted as u, particular video as v and particular query as q. kᵥ and k_{q} indicate the number of unique users interacting with a particular video or query:

$${k}_{v} = {\sum }_{u} {a}_{uv}$$

$${k}_{q} = {\sum }_{u} {b}_{uq}$$

Engine 1411 determines cross-occurrences 1603 relevant to the query and based on the matrix representations of historical viewing and querying behavior. In one embodiment, the cross-occurrence K between queries and videos is composed of cross-occurrence counts for specific query-video combinations. This cross-occurrence count is defined as the number of unique users who issued query q and also watched video v:

$$K = \{ {k}_{qv} \} = {\sum }_{u} {a}_{uv} {b}_{uq} = {B}^{′} A$$

The cross-occurrence reduces to the more familiar co-occurrence when A and B are identical,

$${\{ {A}^{′} A \}}_{{v}_{1} {v}_{2}} = {\sum }_{u} {a}_{{uv}_{1}} {a}_{{uv}_{2}} .$$

For example, a video-to-video cross-occurrence reduces to a video co-occurrence.

The cross-occurrence of queries versus videos is thus a matrix with |Q| rows and |V| columns,

$$K = ( \begin{matrix}{k}_{11} & … & {k}_{1 \vert V \vert} \\ M & O & M \\ {k}_{\vert Q \vert 1} & … & {k}_{\vert Q \vert \vert V \vert}\end{matrix} ) , {k}_{qv} \geq 0 ∀ q , v$$

In one embodiment, engine 1411 tests 1604 for elements of K that are anomalously large. “Anomalously” here refers to values larger than would be expected simply from the overall frequencies k_{q} and kᵥ if interactions by users with q and v were occurring independently. In one embodiment, the test 1604 for anomalously large elements is implemented using a log-likelihood ratio test as described in Ted E. Dunning, Accurate Methods For The Statistics Of Surprise And Coincidence, Computational Linguistics, 19(1):61-74, 1993. To apply this test, a contingency table is constructed that contrasts the interactions with q versus interactions with v.

| | Users viewing υ | All others | Row totals |
|---|---|---|---|
| Users asking q | k_{qν} | k_{q} − k_{qν} | k_{q} |
| All others | k_{ν} − k_{qν} | \|U\| − k_{q} − k_{ν} + k_{qν} | \|U\| − k_{q} |
| Column totals | k_{υ} | \|U\| − k_{ν} | \|U\| |

The first row of the contingency table represents rows of B that contain non-zero elements in column q. The second row of the contingency table represents the remaining rows of B. The first column of the contingency table represents rows of A that contain non-zero elements in column v while the second column of the contingency table represents the rest of the rows of A. For clarity here, the marginal sums of the rows and columns of the contingency table are included in addition to the 4 elements of the contingency table itself. In one embodiment, engine 1411 uses the four quantities k_{qv}, k_{q}, kᵥ and |U| to compute three of the elements of the contingency table. The value |U| is the total number of unique users.

The log-likelihood ratio test statistic −2 log λ can be computed using

$$- 2 log λ = 2 ( \begin{matrix}H [ \begin{matrix}{k}_{qv} & {k}_{q} - {k}_{qv} \\ {k}_{v} - {k}_{qv} & \vert U \vert - {k}_{q} - {k}_{v} + {k}_{qv}\end{matrix} ] - \\ H [ {k}_{v} \vert U \vert - {k}_{v} ] - H [ \begin{matrix}{k}_{q} \\ \vert U \vert - {k}_{q}\end{matrix} ]\end{matrix} )$$

where H is the un-normalized entropy,

$$H [ X ] = - {\sum }_{ij} {x}_{ij} log \frac{{x}_{ij}}{{\sum }_{ij} {x}_{ij}}$$

The log-likelihood ratio statistic given here is well known to be asymptotically χ²(1) distributed in the case of independent q and v. Note that since

$${lim}_{u \to 0} u log u = 0 ,$$

we take 0 log 0=0 to account for cases where one of the elements of the contingency table is zero. Note also that the log-likelihood ratio, −2 log λ, is always non-negative.

In one embodiment, the signed square root of the log-likelihood ratio, s_{qv}, is used as the actual filter statistic to avoid selecting qv pairs which occur less often than expected.

s_{qv}=signum(k_{qv}|U|−k_{q}kᵥ)\sqrt{−2 log λ}

This signed score has asymptotically unit normal distribution which makes the scale of the statistic more familiar to those with basic statistical knowledge.

Based on the score, engine 1411 generates 1605 filtered co-occurrence matrix, K*,

$${K}_{qv}^{*} = \{ \begin{matrix}1 & if {s}_{qv} \geq α \\ 0 & otherwis\end{matrix}$$

In one embodiment, the threshold α is set to be in the range from 3 to 10. The resulting K* is very sparse.

Engine 1411 can then use 1606 the generated filtered co-occurrence matrix K* for searches, recommendations, and/or as a source of additional meta-data for a conventional search engine. To use K* for searches 1606 (such as for videos or other content), in one embodiment engine 1411 retrieves a single row of K*. Since K* is very sparse, this can be very fast. In matrix terms, a search is equivalent to doing K* e_{q} where e_{q} is the unit vector with the q-th component equal to 1 (and all others zero).

Engine 1411 can use 1607 the filtered cross-occurrence matrix for recommendations (such as for videos or other content) as in the product (K*K*′) z where z is a list of videos. This formulation has interesting smoothing properties that conventional co-occurrence-based methods generally lack. In addition, by providing access to the intermediate product K*′ z, engine 1411 is able to provide a human-readable rationale for the recommendations it is giving. This explanation is available because the intermediate product K*′ z is itself a list of queries which would recommend any of the videos in z. As such, this list of queries provides a natural language summary of what the system knows about the videos in the viewing history z.

In one embodiment, engine 1411 uses 1608 the contents of K* as a source of additional meta-data for a conventional search engine. For each column v of K*, engine 1411 adds the text of the queries associated with non-zero values as textual meta-data to video v in a conventional search engine (not shown) that already contains textual meta-data fields such as title and description. This provides a way for conventionally generated search results to be merged with the results of query-to-video recommendations generated by engine 1411.

As mentioned above, the particular examples described herein pertain to users, videos and queries; however, one skilled in the art will recognize that the techniques of the present invention can apply to any types of objects, particularly if some mechanism exists whereby users can interact with the objects. Other examples include, but are not limited to, purchasing music, listening to music, or visiting web pages. Indeed, all three classes of objects can be generalized to a virtual “user” which may or may not be an actual user of a computer system but is any entity that could be seen as having interactions with two other classes of objects. Such an entity could, for example be a business that interacts with consumers and government agencies, or it could be wild animals that interact with predators and food sources such as different fruits, or it could be computers that run different software applications and interact with different network addresses. As such, the system described herein can be used in many contexts.

### Data Flow

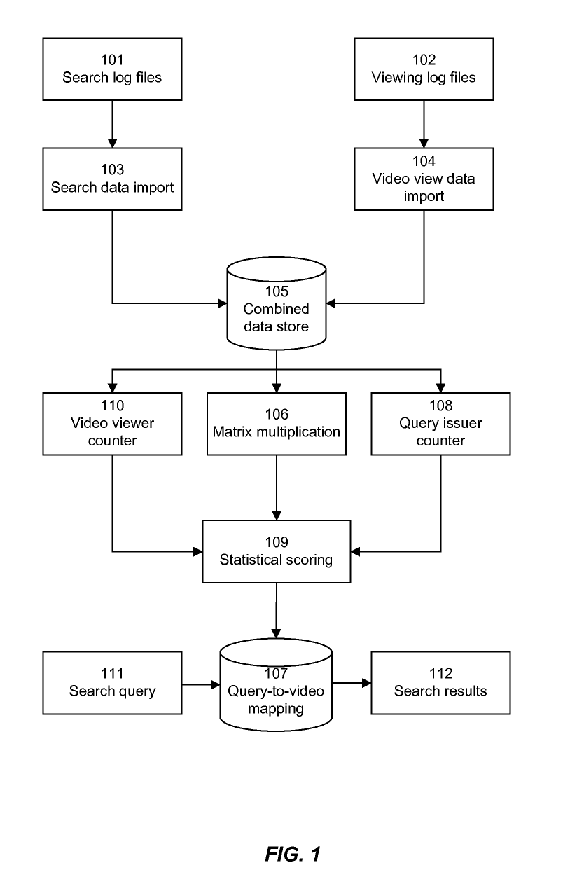

In one embodiment, the various components shown in FIGS. 1 to 4 are implemented using hardware and software depicted in FIG. 14; for example, functional components 106, 107, 108,109, 202, 203, 302, 303, 401, 402 may be implemented as part of search/recommendation engine 1411 located at server 1403. One skilled in the art will recognize that these functional components can be implemented in a single physical device, or as disparate modules that may or may not be remotely located with respect to one another. One skilled in the art will further recognize that these functional components can be implemented as software instructions running on a general purpose or specialized computing device, such as for example server 1403, client machine 1401, or any combination thereof.

Referring now to FIG. 1, there is shown a block diagram depicting data flow from log files to query-to-video mapping, according to one embodiment. User 1408 search behavior and viewing behavior are tracked, for example by software at client machine 1401 and/or at server 1403.

Log files record search behavior 101 and viewing behavior 102 for user 1408 (and possibly other users), and may be stored at data storage 1404 associated with server 1403, and/or at storage 1410 associated with client machine 1401. For illustrative purposes, viewing log files 102 are described herein as containing logs of video viewing, although these files 102 can include logs of views and/or interaction with content of any type.

Search data import process 103 is provided for importing search log files 101, and video view data import 104 process is provided for importing viewing log files 102. The imported files are stored a combined data store 105, which can be in the form of tables in a relational database or any other suitable format. Combined data store 105, in one embodiment, is implemented as part of data storage 1404 associated with server 1403.

In one embodiment, combined data store 105 thus contains all relevant searches and all relevant views for a particular user 1408 and/or for any given set of users 1408. Module 106 performs matrix manipulation to accumulate a set of cross-occurrences in which a particular user 1408 issues a particular query and views a particular video. This matrix multiplication can be implemented, in various embodiments, using sparse matrix methods, sorting, map-reduce or relational database queries, or any combination thereof.

In one embodiment, video viewer counter 110 tracks the number of users 1408 who watched each video, in a set of videos of interest. Query issuer counter 108 tracks the number of users 1408 who issued each query, in a set of queries of interest. Accumulated cross-occurrences as generated by matrix manipulation module 106 are scored relative to the number of unique users 1408 for individual videos and queries as accumulated by counters 107, 108. These cross-occurrence, video and query counts are combined by statistical scoring module 109, resulting in scores that are stored in query-to-video mapping storage 107. In one embodiment, query-to-video mapping storage 107 is implemented as part of data storage 1404 associated with server 1403.

Scores stored in query-to-video mapping storage 107 are subsequently used in processing new queries 111, so as to provide search results 112 that are improved over prior art methods. When a user 1408 issues a new query 111, the query 111 is looked up in query-to-video mapping storage 107, to identify videos that are mapped to query 111. Based on the lookup operation, results 112 are generated and displayed to the user via browser 1405 running at client machine 1401. In one embodiment, data from query-to-video mapping storage 107 is thereby used to generate and/or augment search results 112.

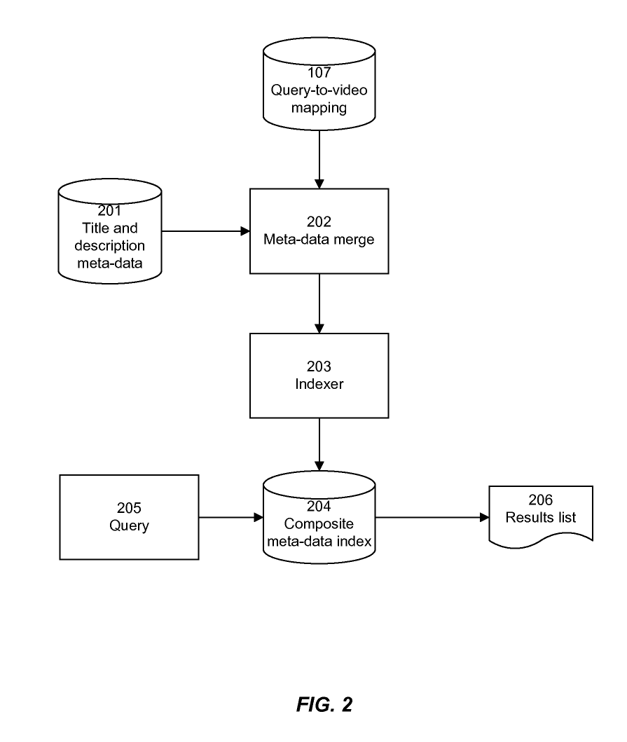

Referring now to FIG. 2, there is shown a block diagram illustrating additional details on the use of the query-to-video mapping data 107 in augmenting search results 112 generated via a text retrieval index according to one embodiment. Meta-data storage 201 stores meta-data relevant to video content items, including for example video titles and descriptions. In one embodiment, meta-data storage 201 is implemented as part of data storage 1404 associated with server 1403; alternatively, it can be implemented as a separate storage mechanism or device. Meta-data merge module 202 merges query-to-video mapping data 107 with meta-data 201. The merged data is processed by text indexer 203 to form composite meta-data index 204; in one embodiment, composite index 204 is data storage 1404 associated with server 1403. In one embodiment, composite meta-data index 204 contains fields for title, description and related queries. The text indexer 203 can be built using conventional software for creating an inverted index, such as Apache Lucene. In one embodiment, engine 1411 uses composite meta-data index 204 to process textual queries 205, for example by using conventional text retrieval techniques, to produce result lists of videos 206.

As an example, suppose that the composite index contained three documents with title and related queries as shown in the table below. A normal text search would match only against the Title field, even though additional information is available in the Related Queries field that would enable the retrieval of document 2 using the query “Nelly”.

| Document Id | Title | Related Queries |
|---|---|---|
| 1 | Siudia/Buleria | Paco de Lucia |
| 2 | Ciara feat Ludacris | Nelly |

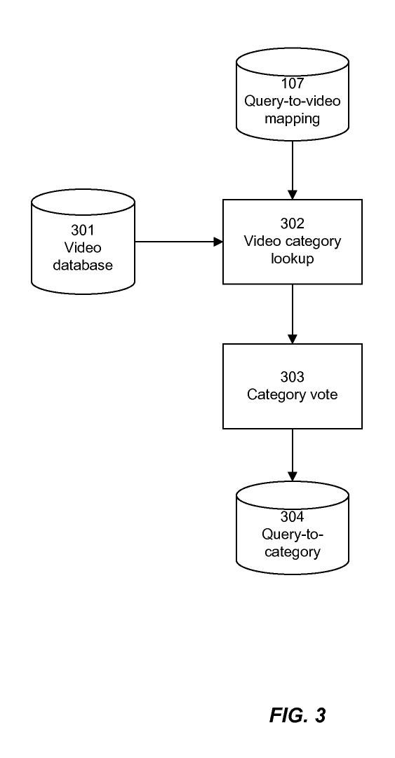

In one embodiment, the system of the present invention uses query-to-video mapping data 107 to categorize queries; query categories can then be attributed back to users 1408 who issued those queries, so as to build a profile that can be used for targeting advertisements as well as other targeting tasks. Referring now to FIG. 3, there is shown a block diagram depicting such query categorization according to one embodiment. In this process, video category lookup module 302 combines query-to-video mapping data 107 with video database 301 that contains a table of videos and category assignments for each video. In one embodiment, queries are mapped to categories using a majority-vote scheme: for a particular query, category vote module 303 counts the categories for videos that are mapped to that query in query-to-video mapping data 107. In one embodiment a query is mapped to a category if the count indicates that one category dominates other categories for videos mapped to that query, or if one category is associated with videos mapped to that query more often than are other categories. In other embodiments, a query can be mapped to more than one category, if appropriate. Query-to-category table 304 stores mappings of queries to categories.

In one embodiment, the above-described technique is extended to produce improved video categorization. In this embodiment, query-to-video mapping data 107 is replaced by (or supplemented by) video-to-video mapping data. Video category lookup module 302 then combines the video-to-video mapping data with video database 301. For a particular video, category vote module 303 counts the categories for videos that are mapped to that video in the video-to-video mapping data. The result is video-to-category mappings that can be stored in a table (not shown), in a similar manner as described above for query-to-category table 304. The contents of this video-to-category table can be used to structure a web-site by providing links from web pages for each category to the related videos as indicated in the video-to-category table.

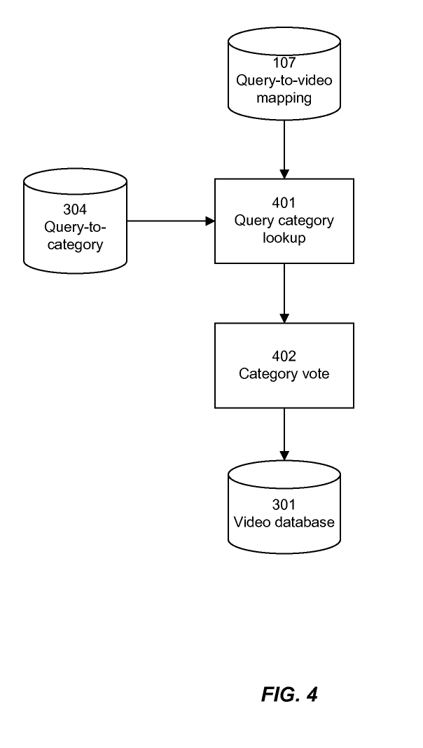

In one embodiment, the system of the present invention uses derived query categories to generate more accurate category mappings for videos. These improved category mappings for videos can be compared to the original video category mappings that were used to derive the query categories, so as to identify miscategorized videos and correct the miscategorizations. Referring now to FIG. 4, there is shown a block diagram depicting a technique for derivation of category assignments for videos using derived query categories and a set of query-to-video mappings, according to one embodiment. Query category lookup module 401 combines query-to-video mapping data 107 (generated as described above in connection with FIG. 1) and query-to-category mapping data 304 (generated as described above in connection with FIG. 3) to produce a count indicating how many queries of each category are associated with each video. In this manner, query-to-video mapping data 107 and query-to-category mapping data 304 are combined to yield video-to-category data. In one embodiment, query category lookup module 401 performs this combination by using query-to-video mapping data 107 in a reverse lookup fashion, so as to identify queries associated with a particular video are found rather than finding videos associated with a particular query.

In one embodiment, videos are mapped to categories using a majority-vote scheme: for each video, category vote module 402 counts the categories mapped to that video by category lookup module 401. If one category dominates these counts 402, then the categorization is stored in video database 301, replacing (or supplementing) any previous categorizations that may have been erroneous.

### EXAMPLE

### Increased Recall

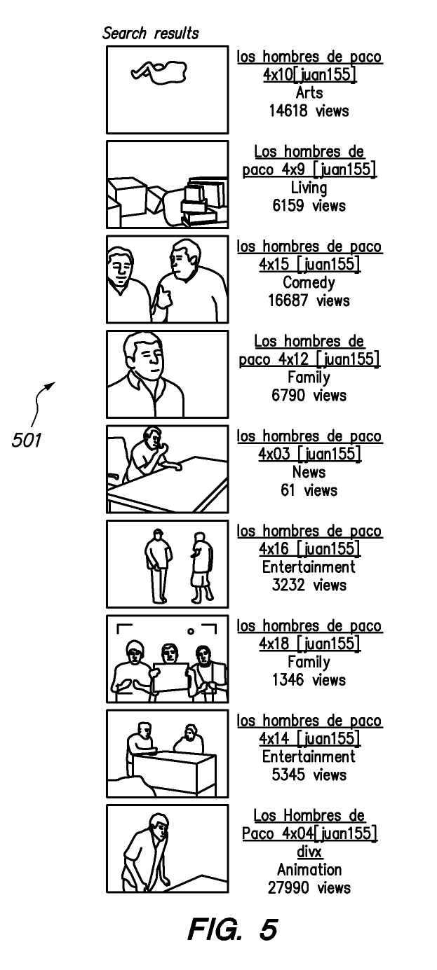

FIGS. 5 through 7 depict examples illustrating the ability of the present invention to improve recall, particularly when the original query yields few or no satisfactory results using conventional methods.

Referring now to FIG. 5, there are shown results 501 of a conventional text search using the query “paco de lucia”, as might be generated by a weighted term retrieval engine for searching for video content, according to the prior art. In this example, the query is the name of a famous flamenco guitarist, but results 501 are dominated by references to episodes of a video program known as “Los Hombres de Paco” due to the word “paco” being in both query and the title of these videos. In fact, in this example, the search corpus does not contain any videos that have obvious references to the guitarist Paco de Lucia. As can be seen, the prior art search engine being used in this example yields unsatisfactory results in such situations where the search corpus does not contain items that are directly referenced by the query terms. Specifically, the search engine generates results that tend to be unrelated to the intent of the query.

Using techniques described above, the system of the present invention can significantly improve search results in such situations by employing a filtered cooccurrence matrix. By observing which queries tend to co-occur with the originally submitted query, the system of the present invention is able to generate results that are more likely to be of interest to the user even when little or no content directly related to the original query exists.

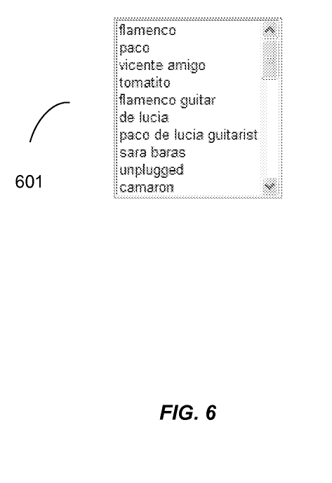

Referring now to FIG. 6, there are shown queries 601 that are related to the “paco de lucia” query according to co-occurrence analysis. Related queries such as “flamenco”, “flamenco guitar” and others show that there is significant coherence captured from the user query histories by the co-occurrence analysis, even though in this case no content is available that is directly related to the original query.

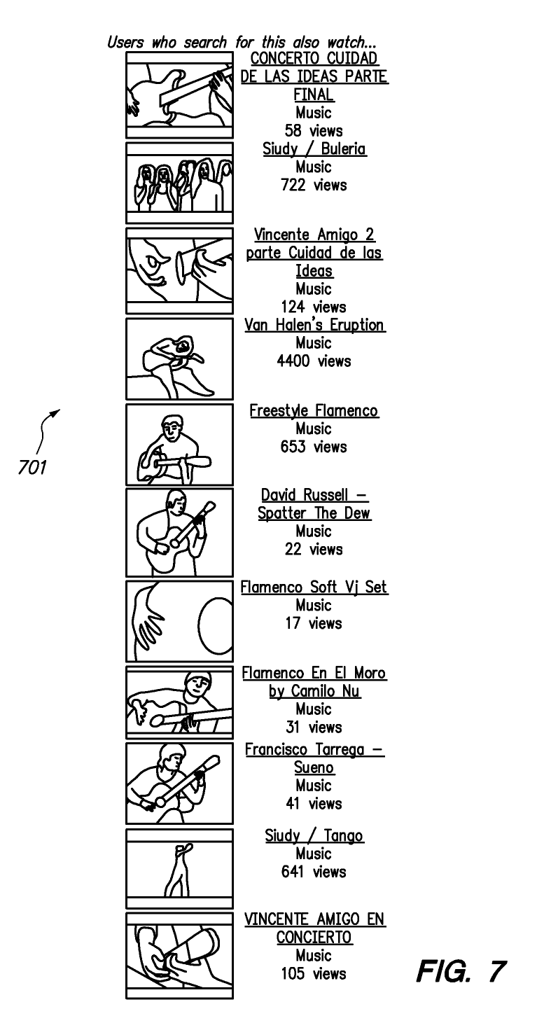

Referring now to FIG. 7, there are shown search results 701 retrieved from the row of K* for the query “paco de lucia”, according to the techniques described above. Results 701 thus represent results associated with queries that are related by co-occurrence to the original query. These include classical guitar performances, a performance of Buleria (a kind of flamenco dance) and other kinds of virtuoso guitar performance. Thus, although no videos featuring Paco de Lucia himself are presented because there are none in the corpus being searched, results 701 feature videos that are closely related to the original query and are likely to be of interest to the user who issued the query “paco de lucia”.

### EXAMPLE

### Improved Precision

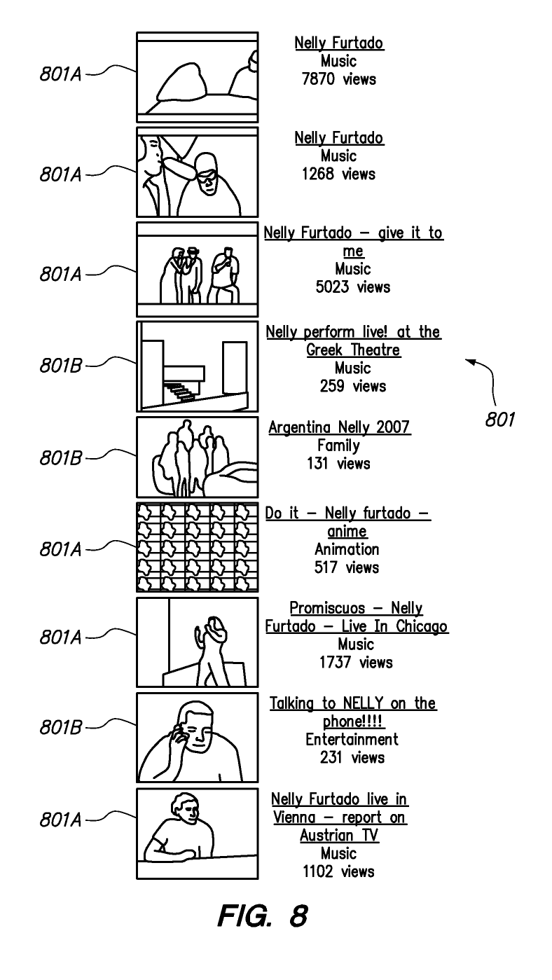

FIGS. 8 through 10B depict examples illustrating the ability of the present invention to improve precision of search results, particularly when the original query is potentially ambiguous.

Referring now to FIG. 8, there are shown results 801 of conventional text search using the query “nelly”, as might be generated by a weighted term retrieval engine for searching for video content, according to the prior art. The query is the stage name of a rapper Cornell Haynes, Jr, but there is textual ambiguity relative to the singer Nelly Furtado. In normal usage, however, it is very unusual to refer to Nelly Furtado simply by her first name while the rapper is almost exclusively referred to by the single word stage name.

As can be seen, the prior art search engine being used in this example yields unsatisfactory results. Of the nine displayed results 801, six results 801A refer to videos related to Nelly Furtado, and only three results 801B refer to videos related to the rapper Nelly. Thus, assuming the user intended to search for videos related to Nelly, these results are imprecise and unsatisfactory, yielding many results that are unrelated to the intent of the query. In this case, the problem arises from the fact that videos concerning Nelly Furtado are often described with just those two words, while videos having to do with the rapper are common described with “Nelly” plus a song title. Thus, results related to Nelly Furtado appear to be more closely related to the “nelly” query, causing conventional search results 801 to be dominated by such videos.

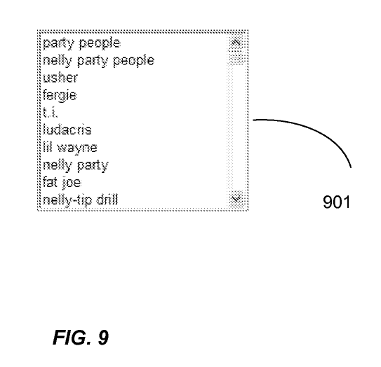

Referring now to FIG. 9, there are shown queries 901 that are related to the “nelly” query according to co-occurrence analysis. The related queries 901 are all related to Nelly (Party People is a popular song by Nelly) or regarding closely related artists. Thus, the co-occurrence analysis in this case serves to resolve the ambiguity posed by this query.

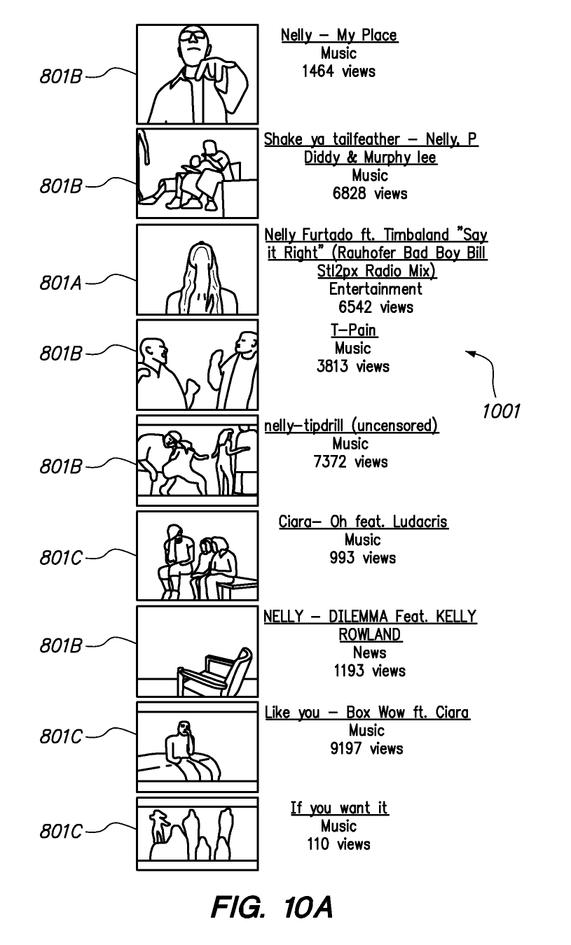

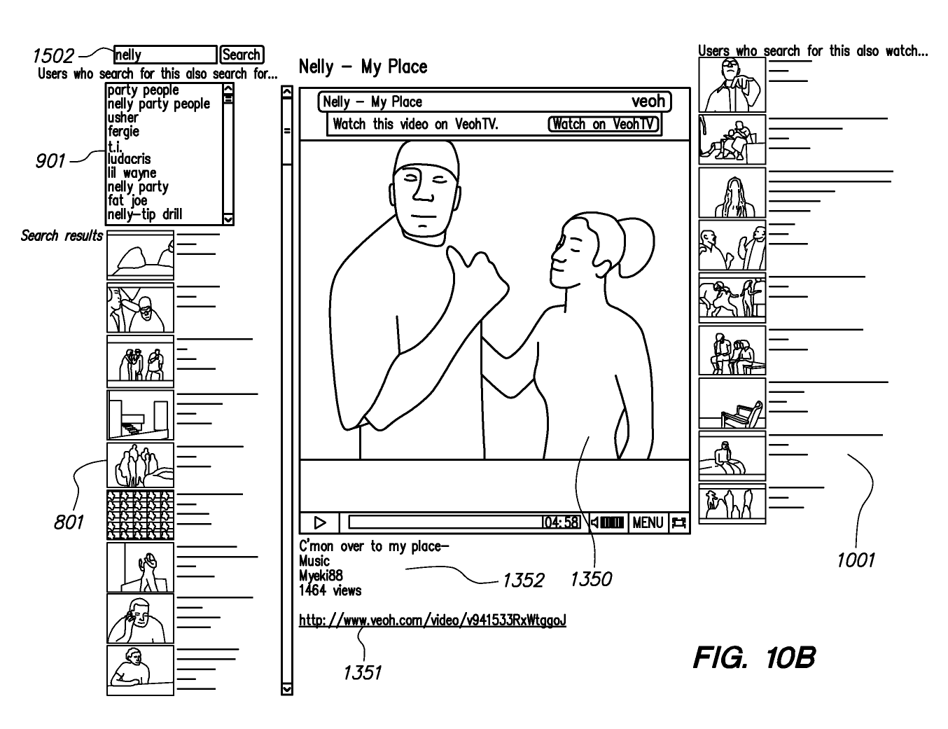

Referring now to FIG. 10A, there are shown search results 1001 retrieved from the row of K* for the query “nelly”, representing query-to-video recommendations according to the techniques described above. Results 1001 thus represent results associated with queries that are related by co-occurrence to the original query. Of the nine displayed results 1001, eight reflect the intended interpretation of the query: five results 801B are related to the rapper Nelly, and three results 801C are related to similar artists such as Ludacris. Only one result 801A relates to Nelly Furtado.

Referring now to FIG. 10B, there is shown an example of a user interface for presenting search results generated using query-to-video mapping, according to one embodiment. One skilled in the art will recognize that the user interface depicted in FIG. 10B is merely exemplary, and that other arrangements, layouts, and features can be implemented.

In one embodiment, as shown in FIG. 10B, the user interface includes search field 1502 for entry of query term(s). In the example, the user has typed the query “nelly” in search field 1502. Related queries 901 are shown, as described above in connection with FIG. 9. Also shown are results 801 of conventional text search using the query “nelly”, as described above in connection with FIG. 8, and search results 1001 retrieved from the row of K* for the query “nelly”, as described above in connection with FIG. 10A.

In one embodiment, user 1408 can select a displayed result from 801 or 1001 for playback on player 1350 within the user interface. In the example of FIG. 10B, player 1350 is playing a selected video from results 1001. The user interface also includes a title (“Nelly—My Place”), additional information 1352 such as lyrics, category and/or number of views, and link 1351 indicating where the video can be found on the Internet.

Therefore, the example illustrates the ability of the present invention to improve precision of search results, by returning a greater number of results related to the intent of the original query.

### EXAMPLE

### Handling Misspelled Query Terms

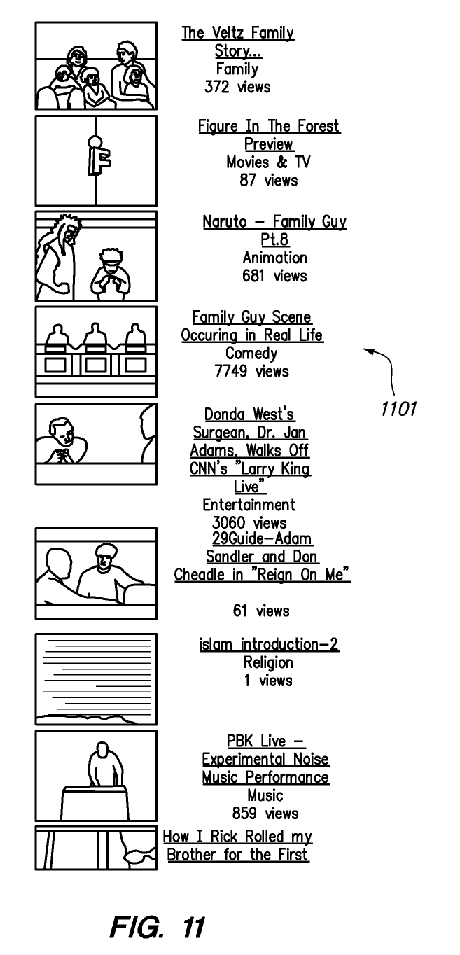

FIGS. 11 through 13 depict examples illustrating the ability of the present invention to handle a misspelled query term. The query “adams family” was submitted, although the user intended to submit “addams family”, referring to the television program. In general, conventional search engine spelling correction techniques may not work to correct this query because the individual terms “adams” and “family” are so common and because the misspelled compound is common as well.

Referring now to FIG. 11, there are shown results 1101 of conventional text search using the misspelled query “adams family”, as might be generated by a weighted term retrieval engine for searching for video content, according to the prior art. Results 1101 include no items that relate to the intended query.

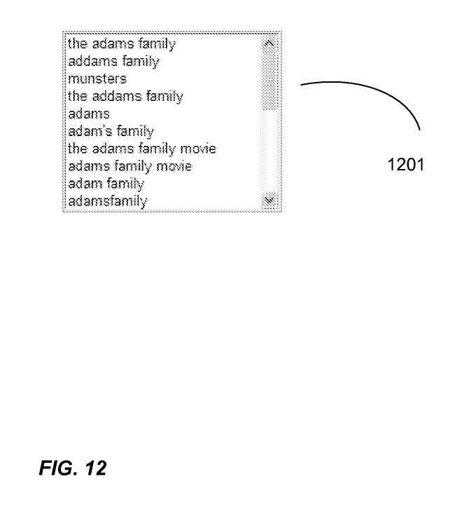

Referring now to FIG. 12, there are shown queries 1201 that are related to the “adams family” query according to co-occurrence analysis. The related queries 901 include another misspelled variant of the query as well as correctly spelled variants and other related queries. Thus, the co-occurrence analysis in this case serves to correct the misspelling in the original query.

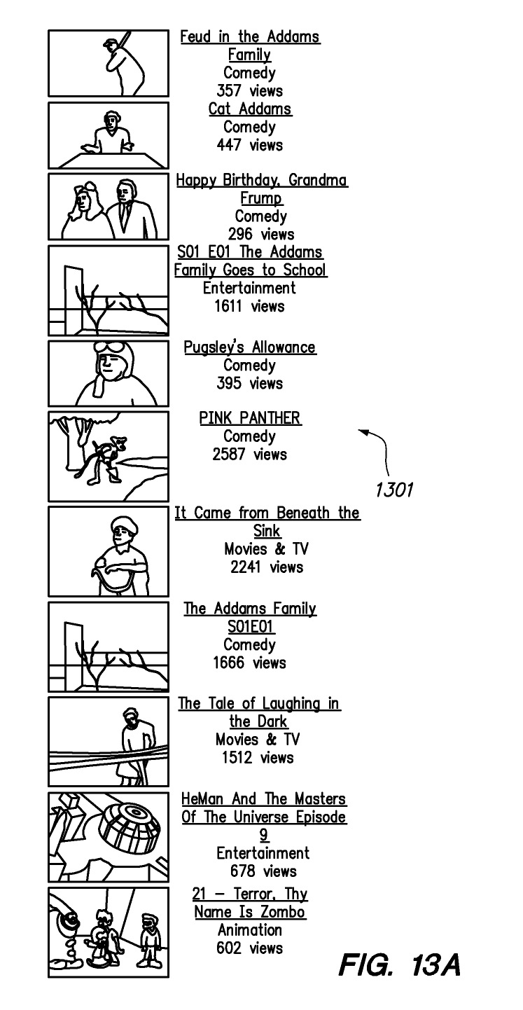

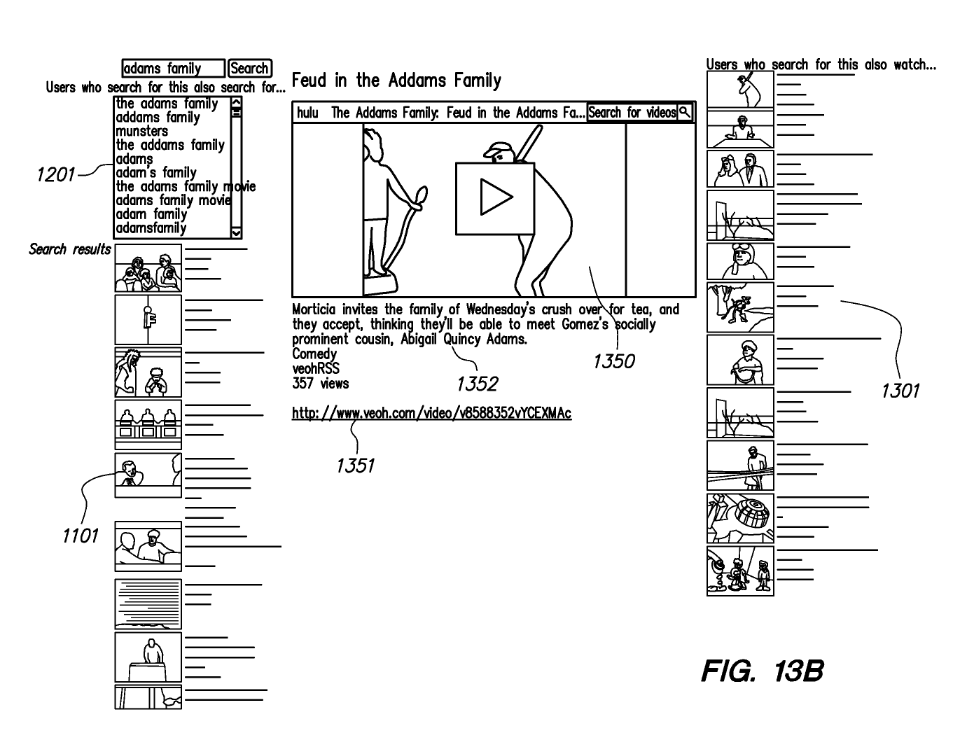

Referring now to FIG. 13A, there are shown search results 1301 retrieved from the row of K* for the query “adams family”, representing query-to-video recommendations according to the techniques described above. Results 1301 thus represent results associated with queries that are related by co-occurrence to the original query. Of the eleven displayed results 1301, several reflect the intended interpretation and spelling of the query. Results 1301 include, for example, several video items from the original “Addams Family” television series as well as other television series from the same era.

Referring now to FIG. 13B, there is shown an example of a user interface for presenting search results for a misspelled query, improved by filtered cooccurrence according to one embodiment. One skilled in the art will recognize that the user interface depicted in FIG. 13B is merely exemplary, and that other arrangements, layouts, and features can be implemented.

In one embodiment, as shown in FIG. 13B, the user interface includes a search field for entry of query term(s). In the example, the user has typed the query “adams family” in the search field. Related queries 1201 are shown, as described above in connection with FIG. 12. Also shown are results 1101 of conventional text search using the misspelled query “adams family”, as described above in connection with FIG. 11, and search results 1301 retrieved from the row of K* for the query “adams family”, as described above in connection with FIG. 13A.

In one embodiment, user 1408 can select a displayed result from 1101 or 1301 for playback on player 1350 within the user interface. In the example of FIG. 13B, player 1350 is playing a selected video from results 1301. The user interface also includes a title (“Feud in the Addams Family”), additional information 1352 such as lyrics, category and/or number of views, and link 1351 indicating where the video can be found on the Internet.

The present invention has been described in particular detail with respect to possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

In various embodiments, the present invention can be implemented as a system or a method for performing the above-described techniques, either singly or in any combination. In another embodiment, the present invention can be implemented as a computer program product comprising a computer-readable storage medium and computer program code, encoded on the medium, for causing a processor in a computing device or other electronic device to perform the above-described techniques.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared, transformed, and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware and/or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers and/or other electronic devices referred to in the specification may include a single processor or may be architectures employing multiple processor designs for increased computing capability.

The algorithms and displays presented herein are not inherently related to any particular computer, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

Accordingly, in various embodiments, the present invention can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the invention include: a mobile phone, personal digital assistant, smartphone, kiosk, desktop computer, laptop computer, consumer electronic device, television, set-top box, or the like. An electronic device for implementing the present invention may use an operating system such as, for example, Microsoft Windows Vista available from Microsoft Corporation of Redmond, Wash., or any other operating system that is adapted for use on the device.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A computer-implemented method for generating search results based on a query for a content item, comprising:
at an input device, receiving user input representing a query from a user;
obtaining representations of historical relationships between a plurality of users and a plurality of content items;
obtaining representations of historical relationships between a plurality of users and a plurality of queries;
determining, from the obtained representations, cross-occurrences relevant to the query;
generating search results based on the determined cross-occurrences; and
at an output device, outputting at least a subset of the generated search results.

2. The method of claim 1, wherein:
the representations of historical relationships between a plurality of users and a plurality of content items comprise representations of user interactions with content items; and
the representations of historical relationships between a plurality of users and a plurality of queries comprise representations of user submissions of queries.

3. The method of claim 1, wherein determining cross-occurrences comprises determining how many unique users issued a particular query and also interacted with a particular content item.

4. The method of claim 1, wherein:
the representations of historical relationships between a plurality of users and a plurality of content items comprise a first matrix representing user interactions with content items;
the representations of historical relationships between a plurality of users and a plurality of queries comprise a second matrix representing user submissions of queries; and
determining cross-occurrences comprises generating a cross-occurrence matrix from the first and second matrices, the cross-occurrence matrix representing a quantity of unique users who issued a query and also interacted with a particular content item.

5. The method of claim 4, wherein determining cross-occurrences further comprises:
identifying elements of the cross-occurrence matrix having values exceeding a threshold; and
generating a filtered co-occurrence matrix using the identified elements.

6. The method of claim 5, wherein the threshold represents a value that would be expected from overall frequencies of relationships between users and content items and overall frequencies of relationships between users and queries, were such relationships independent of one another.

7. The method of claim 5, further comprising retrieving a single row of the filtered co-occurrence matrix to generate at least one selected from the group consisting of:
at least one search result;
at least one recommendation; and
meta-data for a search engine.

8. The method of claim 1, wherein each content item comprises a video.

9. The method of claim 8, wherein the representations of historical relationships between a plurality of users and a plurality of content items comprise representations of a number of times each user has played each video.

10. A computer program product for generating search results based on a query for a content item, comprising:
a computer-readable storage medium; and
computer program code, encoded on the medium, for causing a processor to perform the steps of:
at an input device, receiving user input representing a query from a user;
obtaining representations of historical relationships between a plurality of users and a plurality of content items;
obtaining representations of historical relationships between a plurality of users and a plurality of queries;
determining, from the obtained representations, cross-occurrences relevant to the query;
generating search results based on the determined cross-occurrences; and
at an output device, outputting at least a subset of the generated search results.

11. The computer program product of claim 10, wherein:
the representations of historical relationships between a plurality of users and a plurality of content items comprise representations of user interactions with content items; and
the representations of historical relationships between a plurality of users and a plurality of queries comprise representations of user submissions of queries.

12. The computer program product of claim 10, wherein the computer program code for causing a processor to perform the step of determining cross-occurrences comprises computer program code for causing a processor to perform the step of determining how many unique users issued a particular query and also interacted with a particular content item.

13. The computer program product of claim 10, wherein:
the representations of historical relationships between a plurality of users and a plurality of content items comprise a first matrix representing user interactions with content items;
the representations of historical relationships between a plurality of users and a plurality of queries comprise a second matrix representing user submissions of queries; and
the computer program code for causing a processor to perform the step of determining cross-occurrences comprises computer program code for causing a processor to perform the step of generating a cross-occurrence matrix from the first and second matrices, the cross-occurrence matrix representing a quantity of unique users who issued a query and also interacted with a particular content item.

14. The computer program product of claim 13, wherein the computer program code for causing a processor to perform the step of determining cross-occurrences further comprises computer program code for causing a processor to perform the step of:
identifying elements of the cross-occurrence matrix having values exceeding a threshold; and
generating a filtered co-occurrence matrix using the identified elements.

15. The computer program product of claim 14, wherein the threshold represents a value that would be expected from overall frequencies of relationships between users and content items and overall frequencies of relationships between users and queries, were such relationships independent of one another.

16. The computer program product of claim 14, further comprising computer program code for causing a processor to perform the step of retrieving a single row of the filtered co-occurrence matrix to generate at least one selected from the group consisting of:
at least one search result;
at least one recommendation; and
meta-data for a search engine.

17. The computer program product of claim 10, wherein each content item comprises a video.

18. The computer program product of claim 17, wherein the representations of historical relationships between a plurality of users and a plurality of content items comprise representations of a number of times each user has played each video.

19. A system for generating search results based on a query for a content item, comprising:
an input device, for receiving user input representing a query from a user;
a storage device, for storing representations of historical relationships between a plurality of users and a plurality of content items and representations of historical relationships between a plurality of users and a plurality of queries;
a search/recommendation engine, for determining, from the stored representations, cross-occurrences relevant to the query and for generating search results based on the determined cross-occurrences; and
an output device, for outputting at least a subset of the generated search results.

20. The system of claim 19, wherein:
the representations of historical relationships between a plurality of users and a plurality of content items comprise representations of user interactions with content items; and
the representations of historical relationships between a plurality of users and a plurality of queries comprise representations of user submissions of queries.

21. The system of claim 19, wherein the search/recommendation engine determines cross-occurrences by determining how many unique users issued a particular query and also interacted with a particular content item.

22. The system of claim 19, wherein:
the representations of historical relationships between a plurality of users and a plurality of content items comprise a first matrix representing user interactions with content items;
the representations of historical relationships between a plurality of users and a plurality of queries comprise a second matrix representing user submissions of queries; and
the search/recommendation engine determines cross-occurrences by generating a cross-occurrence matrix from the first and second matrices, the cross-occurrence matrix representing a quantity of unique users who issued a query and also interacted with a particular content item.

23. The system of claim 22, wherein the search/recommendation engine:
identifies elements of the cross-occurrence matrix having values exceeding a threshold; and
generates a filtered co-occurrence matrix using the identified elements.

24. The system of claim 23, wherein the threshold represents a value that would be expected from overall frequencies of relationships between users and content items and overall frequencies of relationships between users and queries, were such relationships independent of one another.

25. The system of claim 23, wherein the search/recommendation engine retrieves a single row of the filtered co-occurrence matrix to generate at least one selected from the group consisting of:
at least one search result;
at least one recommendation; and
meta-data for a search engine.

26. The system of claim 19, wherein each content item comprises a video.

27. The system of claim 26, wherein the representations of historical relationships between a plurality of users and a plurality of content items comprise representations of a number of times each user has played each video.
